(19) United States
(12) Patent Application Publication
(10) Pub. No.: US 2006/0198963 A1
(43) Pub. Date: Sep. 7, 2006

(54) Process for the production of a coating layer on three-dimensional shaped substrates with radiation-curable coating compositions

(76) Inventors: Dimitry Chernyshov, Wuppertal (DE); Fabian Koehn, Wuppertal (DE); Martin Wulf, Langenfeld (DE)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/230,009

(22) Filed: Sep. 19, 2005

Related U.S. Application Data
(60) Provisional application No. 60/658,117, filed on Mar. 3, 2005.

(51) Int. Cl. C08F 2/46

(52) U.S. Cl. 427/487

(57) ABSTRACT

A process for the production of a coating layer on a three-dimensional shaped substrate, comprising the steps: (1) providing a three-dimensional shaped substrate, (2) initial application of a coating layer on the surface of the substrate from a coating composition curable by free-radical polymerization of olefinic double bonds on UV irradiation and (3) irradiating the coated substrate with UV radiation; wherein the coating composition contains the following constituents: A) at least one free-radically polymerizable binder containing olefinically unsaturated groups, B) optionally, at least one free-radically polymerizable monomeric reactive diluent containing one or more olefinically unsaturated groups, C) at least one photoinitiator for free-radical polymerization, and D) at least one metal compound.

### CROSS REFERENCE TO RELATED APPLICATION

This application claims the benefit of U.S. Provisional Application No. 60/658,117, filed Mar. 3, 2005 which is hereby incorporated by references in its entirely.

### FIELD OF THE INVENTION

The invention relates to a process for the production of an original coating layer on three-dimensional shaped substrates using coating compositions, which are curable by free-radical polymerization of olefinic double bonds on irradiation with UV (ultraviolet) light (on exposure to UV light; “UV irradiation” for short).

### DESCRIPTION OF THE PRIOR ART

The production of coatings on three-dimensional shaped substrates using coating compositions curable by free-radical polymerization of olefinic double bonds on UV irradiation is known per se. EP 0 540 884 A1, for example, accordingly describes the production of a clear top coat on automotive bodies provided with a base coat layer using a clear coating composition curable by free-radical polymerization of olefinic double bonds on UV irradiation. In relation to the problem of curing those areas of the clear coat film located in shaded zones (shadow zones; those areas of the surface which are inaccessible to direct irradiation with UV light and which receive only a fraction of the UV radiation dose to which those areas directly accessible to the UV irradiation are exposed), EP 0 540 884 A1 proposes using punctual, small area or omnidirectional radiation sources in conjunction with an automatic motion apparatus in order to permit UV irradiation of interior or engine compartments, cavities or edges.

Curing within shaded zones may also be achieved by using “dual-cure” coating compositions known to the person skilled in the art which contain binder systems containing not only components curable by the free-radical polymerization of olefinic double bonds on UV irradiation but also thermally curable components. Coating films applied from dual-cure coating compositions are cured by UV irradiation and by use of thermal energy. Zones of the dual-cure coating located in shaded zones are accordingly subjected to at least the thermal part of curing. To this extent, a usable surface is obtained in shaded zones, even if that part of curing due to the free-radical polymerization of olefinic double bonds does not proceed or proceeds only inadequately due to inadequate UV light access.

It is desirable to provide a process performed for the purposes of original coating for the production of a coating layer, for example, a clear top coat, on three-dimensional shaped substrates, in particular automotive bodies, using a coating composition curable by free-radical polymerization of olefinic double bonds on UV irradiation without having to use special equipment to achieve purposeful UV irradiation of the shaded zones. In other words, the process to be found should permit in each case adequate curing of a coating layer applied from a coating composition curable by free-radical polymerization of olefinic double bonds on UV irradiation onto three-dimensional shaped substrates by UV radiation-induced free-radical polymerization of olefinic double bonds both in those areas directly accessible to UV irradiation, such as, for example, the outer skin, and in shaded zones of the three-dimensional shaped substrates, without having to use elaborate equipment to achieve purposeful UV irradiation of the shaded zones.

A fundamental problem when coating with coating compositions curable with UV irradiation is the negative influence of atmospheric oxygen on the surface of the coating layer wherein the oxygen disrupts the photochemically induced free-radical polymerization of the coating layer as it is cured. In other words, there is the problem of inhibition of the polymerization reaction by atmospheric oxygen, which results in insufficient curing of the surface of an applied coating film, which exhibits, for example, inadequate hardness. The inhibition is caused by the competitive reactions, which occur during free-radical polymerization in the presence of atmospheric oxygen, wherein the oxygen reacts with the free radicals arising at the surface and the latter are no longer available in their entirety for the polymerization reaction.

Various methods have already been developed for avoiding or reducing oxygen inhibition. One possibility is to use chemically modified resins, for example, in the case of unsaturated polyester resins, the inhibition effect may be overcome by incorporation of allyl ether groups. Trimethylolpropane diallyl ether may, for example, be used for this purpose. Another possibility, in principle, is to work in an inert gas atmosphere with exclusion of oxygen. Nitrogen or a carbon dioxide/nitrogen mixture is conventionally used for this purpose. It is also known to avoid oxygen inhibition by adding paraffins or similar waxy substances to the coating composition, which form a protective film on the surface of the applied coating film.

While these stated approaches do indeed in principle solve or minimize the problem of inhibition by atmospheric oxygen, they also cause additional difficulties with regard to process control or achieving certain technological properties of the coatings.

It has now been found that it is possible to coat three-dimensional shaped substrates with coating compositions curable by free-radical polymerization of olefinic double bonds on UV irradiation and to cure successfully by irradiation with UV light in a conventional atmosphere, i.e., despite the presence of atmospheric oxygen, if the per se known coating compositions contain specific metal compounds. In this case, it is not necessary to use either of the measures to exclude atmospheric oxygen or dual-cure coating compositions. It should be noted that successful curing is taken to mean that the curing will ensure that a usable coating layer also will be formed in the shaded zones, which can receive only a fraction of the UV radiation that is directly applied to the surface of the un-shaded zones of the coating layer (areas of the surface which are directly accessible to the UV radiation). However, those areas of the surface directly accessible to the UV radiation also cure better as if an identical coating composition that does not contain the metal compounds were used. Better curing is manifested by improved technical properties of the cured coating layer (stronger crosslinking) or it is possible to use a smaller UV radiation dose than is typically used for corresponding coating compositions that do not contain the metal compounds. This results in shorter transit times of UV irradiation and/or in energy savings. Moreover, greater uniformity in crosslinking status within the coating layer itself may be achieved, i.e., the degree of conformity between the crosslinking status of the outer proportion of the coating layer oriented towards the environment (outermost few percent of coating layer thickness) and that of the proportion of the coating layer oriented towards to the substrate surface (remaining percentage of coating layer thickness) is greater or the degree of crosslinking is even identical within the entire coating layer.

### SUMMARY OF THE INVENTION

The invention is directed to a process for the production of a coating layer on a three-dimensional shaped substrate, comprising the steps:
(1) providing a three-dimensional shaped substrate,
(2) initial application of a coating layer on the surface of the substrate from a coating composition curable by free-radical polymerization of olefinic double bonds on UV irradiation and
(3) irradiating the coated substrate with UV radiation; wherein the coating composition contains the following constituents:
A) at least one free-radically polymerizable binder containing olefinically unsaturated groups,
B) optionally, at least one free-radically polymerizable monomeric reactive diluent containing one or more olefinically unsaturated groups,
C) at least one photoinitiator for free-radical polymerization, and
D) at least one metal compound selected from the group consisting of metal salt compounds containing the metal in the cation and/or anion of the compound, organometallic compounds, metal coordination compounds and combinations thereof, wherein said metal or metals is/are selected from the group consisting of metals of groups 13 and 14 of the periodic system of elements and transition metals, which metals or transition metals are able to occur in at least 2 oxidation states other than zero.

### DETAILED DESCRIPTION OF THE EMBODIMENTS

The process according to the invention is a process for the production of a coating layer for the purposes of original coating and not, for instance, a repair coating process, as is expressed by the phrase “initial application of a coating layer” used above in connection with process step (2). The process according to the invention is preferably performed on an industrial scale, i.e., for the purpose of industrial mass-production coating, in particular, in the context of automotive original coating.

In step (1) of the process according to the invention, a three-dimensional shaped substrate is provided, which in process step (2) is provided for the purposes of original coating with a coating layer of a coating composition curable by free-radical polymerization of olefinic double bonds on exposure to UV radiation (hereinafter also referred to in short merely as “coating composition”).

The phrase “three-dimensional shaped substrate” means that the substrate has no plane surface, such as, for example, a sheet metal panel, but instead the surface thereof comprises a shape, i.e., has, for example, at least one curved zone domain and/or at least one bead. In the case of complex three-dimensional substrates, which may be composed of two or more components of identical or different materials, certain portions of the surface are within the above-mentioned shaded zones, i.e., such substrates have one or more outer surfaces which are directly accessible to an external observer and to spray coating and one or more surfaces which are not directly accessible to an external observer but are in principle accessible to spray coating.

The phrase “one or more surfaces which are not directly accessible to an external observer but are in principle accessible to spray coating” means surfaces located in shaded zones, which surfaces are purposefully spray coated in part or in their entirety or, during spray coating of the surfaces directly accessible to an external observer, are at least exposed to overspray. Just for completeness' sake, it should be noted that the surface(s) of a three-dimensional shaped substrate which is/are directly accessible to an external observer and to spray coating also does/do not generally receive the same UV radiation dose at every point during UV irradiation, as the UV radiation sources generally are not or cannot be exactly adapted to the surface outline of the three-dimensional shaped substrate.

Examples of three-dimensional shaped substrates are in particular automotive bodies and body parts.

In the case of automotive bodies, the outer surfaces which are directly accessible to an external observer and to spray coating comprise all of the immediately visible metal outer body skin with the doors, bonnet and boot lid closed, including any externally visible surface portions made from other materials such as in particular plastics. Accordingly, surfaces which are not directly accessible to an external observer but are in principle accessible to spray coating are internal surfaces of the automotive body which, with the bonnet, doors and boot lid closed, are not accessible to an external observer but, once the bonnet, doors and boot lid have been opened, are in principle accessible to spray coating. Examples include surfaces belonging to door entries (surface of the frame-like door opening in the body; internal surfaces of the door, i.e., door frame and inner side of door), surfaces of the boot and engine compartment, inner sides of boot lid and bonnet, visible surfaces of the passenger compartment, but not the underbody and concealed surfaces which are fundamentally inaccessible to spray coating, such as, surfaces behind undercuts or internal surfaces of cavities.

The coating layer applied in process step (2) may be applied as a single-layer coating or as a coating layer within a multilayer coating. The three-dimensional shaped substrates may accordingly be uncoated or have a precoating of one or more coating layers. If the coating composition used in process step (2) is applied for the production of an outer, final clear coat layer of a multilayer coating, the precoating in general is a color-determining, in particular a color- and/or special effect-imparting precoating.

In the example of a typical automotive coating comprising electrodeposition primer, primer surfacer (filler) layer, color- and/or special effect-imparting base coat layer and clear coat layer and optionally, in addition a transparent sealing layer, in process step (2) an automotive body provided, for example, with an electrodeposition primer as the precoating may be provided with a primer surfacer layer or an automotive body provided with a precoating of electrodeposition primer, a primer surfacer layer and a color- and/or special effect-imparting base coat layer may be provided with a final clear coat layer or an automotive body provided with a per se ready multilayer coating, for example, of electrodeposition primer, a primer surfacer layer, a color- and/or special effect-imparting base coat layer and a clear coat layer, may be provided with a transparent sealing layer.

Examples of color-determining precoatings on automotive bodies, the structure of which may apart from metal parts also comprise plastics parts, are, in the case of plastics parts, a predried or completely dried, for example, baked, base coat layer applied from a conventional color- and/or special effect-imparting solvent-borne base coat or preferably water-borne base coat, which base coat layer may include one or more coating layers arranged thereunder, for example, a conventional plastics primer layer. In the case of metallic body parts, for example, of steel or aluminum, examples of color-determining precoatings comprise coating structures of a conventional electrodeposition primer and a predried or completely dried, for example, baked, base coat layer applied from a conventional color- and/or special effect-imparting solvent-borne base coat or preferably water-borne base coat, which base coat layer may include one or more coating layers arranged thereunder, for example, a primer surfacer layer or a coating structure consisting of an electrodeposition primer and a primer surfacer layer.

In the case of a metallic automotive body, the precoating on the body surface may be everywhere identical and so color-determining or differ in different zones of the surface and so optionally not everywhere be color-determining. While the entire metal body surface is provided with an electrodeposition coating primer, a base coat layer determining the body color or a corresponding color-determining coating structure may, for example, be applied only onto visually obvious zones of the body surface, for example, in order to save paint. Examples of such visually obvious surface zones are areas visible to the customer on the finished motor vehicle, namely, apart from the outer body skin, the door entries and any areas not covered with trim in the interior of the finished motor vehicle. Less visually significant zones of the body surface, such as, for example, in the boot, on the inner side of the boot lid, in the engine compartment, on the inner side of the bonnet and on trim-covered areas in the interior of the finished motor vehicle, may be coated, in addition to the electrodeposition coating primer, with an interlayer and base coat, or only with interlayer or only with base coat or they comprise no further coating layer other than the electrodeposition coating primer.

The three-dimensional shaped substrates provided in process step (1) are coated in process step (2). The coating compositions used in process step (2) will first of all be described below.

The term (meth)acrylic as used here and hereinafter should be taken to mean methacrylic and/or acrylic.

All molecular weights (both number and weight average molecular weight) referred to herein are determined by GPC (gel permeation chromatography) using polystyrene as the standard, unless otherwise stated.

Component A) comprises one or more free-radically polymerizable binders containing olefinically unsaturated groups. The binders may be oligomeric or polymeric in nature.

Suitable binders having free-radically polymerizable olefinic double bonds that may be considered are, for example, all the binders known to the skilled person that can be cross-linked by free-radical polymerization. These binders are prepolymers, such as, polymers and oligomers containing, per molecule, one or more, preferably on average 2 to 20, particularly preferably, 3 to 10 free-radically polymerizable olefinic double bonds. The polymerizable double bonds may, for example, be present in the form of (meth)acryloyl, vinyl, maleate and/or fumarate groups. The free-radically polymerizable double bonds are particularly preferably present in the form of (meth)acryloyl groups.

Examples of prepolymers or oligomers include (meth)acryloyl-functional (meth)acrylic copolymers, polyurethane (meth)acrylates, polyester (meth)acrylates, unsaturated polyesters, polyether (meth)acrylates, silicone (meth)acrylates and epoxy resin (meth)acrylates. The number average molar weight Mn of these compounds may be, for example, 500 to 10,000 g/mole, preferably, 500 to 5,000 g/mole. The binders may be used individually or as a mixture. (Meth)acryloyl-functional (meth)acrylic copolymers and/or polyurethane (meth)acrylates are preferably used.

The binder(s) of component A) may be used in combination with reactive diluents having one or more unsaturated free-radically polymerizable groups (component B)). The reactive diluents are olefinically mono-, di- or polyunsaturated free-radically polymerizable monomeric compounds. The olefinically unsaturated groups are preferably (meth)acryloyl groups. The reactive diluents have low molecular weights of, for example, below 500 g/mol.

Examples of monounsaturated reactive diluents include: olefinically unsaturated monocarboxylic acids and esters of olefinically unsaturated monocarboxylic acids with aliphatic, cycloaliphatic or aromatic alcohols. Olefinically unsaturated monocarboxylic acids which may be considered are, for example, methacrylic acid, crotonic acid and isocrotonic acid. The alcohols from which the ester residues are derived in particular comprise aliphatic, cycloaliphatic or aromatic, monohydric alcohols having 1- 20 carbon atoms per molecule. Examples of (meth)acrylic acid esters with aliphatic alcohols are methyl acrylate, ethyl acrylate, isopropyl acrylate, tert.-butyl acrylate, n-butyl acrylate, isobutyl acrylate, 2-ethylhexyl acrylate, lauryl acrylate, stearyl acrylate and the corresponding methacrylates. Examples of (meth)acrylic acid esters with cycloaliphatic alcohols are cyclohexyl acrylate, trimethylcyclohexyl acrylate, 4-tert.-butylcyclohexyl acrylate, isobornyl acrylate and the corresponding methacrylates. Examples of (meth)acrylates with aromatic alcohols are benzyl (meth)acrylates.

Further examples of monounsaturated reactive diluents are maleic acid and semi-esters thereof, vinyl acetate, vinyl ethers, substituted vinylureas, styrene, vinyltoluene.

Examples of diunsaturated reactive diluents include: di(meth)acrylates, such as, 1,3-butanediol di(meth)acrylate, hexanediol di(meth)acrylate, dipropylene glycol di(meth)acrylate, polyethylene glycol di(meth)acrylate, vinyl (meth)acrylate, allyl (meth)acrylate, divinylbenzene.

Examples of polyunsaturated reactive diluents include: glycerol tri(meth)acrylate, trimethylolpropane tri(meth)acrylate, pentaerythritol tri(meth)acrylate, pentaerythritol tetra(meth)acrylate. The reactive diluents may be used alone or in mixture.

The coating compositions contain one or more photoinitiators (component(s) C)) for the radical polymerization of component A) and optionally present component B). Suitable photoinitiators include, for example, those that absorb in the wavelength range from 190 to 600 nm. The photoinitiators may be present, for example, in quantities of 0.1 to 5 wt-%, preferably of 0.5 to 3 wt-%, relative to the sum of free-radically polymerizable binders, reactive diluents and photoinitiators. Examples of suitable photoinitiators are benzoin and derivatives thereof, acetophenone and derivatives thereof, for example, 2,2-diacetoxyacetophenone, benzophenone and derivatives thereof, thioxanthone and derivatives thereof, anthraquinone, 1-benzoylcyclohexanol, organophosphorus compounds, such as, acylphosphine oxides. The photoinitiators may be used individually or in combination.

The coating compositions contain as component D) at least one metal compound selected from the group consisting of metal salt compounds containing the metal in the cation and/or anion of the compound, organometallic compounds, metal coordination compounds and combinations thereof. The metal compounds may comprise metal compounds comprising one or more different metals in the respective metal compound. The metal compounds may be used as a combination of metal compounds of one metal or as a combination of metal compounds of different metals. Salt compounds containing the metal in the cation shall include compounds where the metal itself forms the cation. The metal or metals comprise metals of groups 13 and 14 of the periodic system of elements or transition metals, which metals or transition metals are able to occur in at least 2 oxidation states other than zero. Oxidation states other than zero shall mean positive oxidation states.

The term “transition metal” means elements of groups 3 to 12 of the periodic system of elements, including the lanthanoides.

Examples of transition metals which may be used are, for example, titanium, vanadium, chromium, manganese, iron, cobalt, nickel, copper, niobium, molybdenum, palladium, tungsten, platinum and the lanthanoids, in particular cerium. Especially preferred are titanium, vanadium, chromium, manganese, iron, cobalt, nickel, copper and cerium.

Preferred components D) are (transition) metal salts of an organic or inorganic acid.

Examples of organic acids on which the (transition) metal salts may be based are unsaturated higher fatty acids, such as, linseed oil fatty acid, tall oil fatty acid, soy oil fatty acid, resin acids (resinol acids), for example, based on diterpenes, such as, abietic, neoabietic, laevopimaric, pimaric and palustrinic acid and agathic acid, illuric acid and podocarpic acid, naphthenic acid, benzoic acid, acetic acid, oxalic acid and the isomers of octanoic acid, such as in particular 2-ethylhexanoic acid.

Examples of inorganic acids on which the (transition) metal salts may be based are sulfuric acid, phosphoric acid, boric acid, nitric acid and hydrochloric acid.

Substances which may readily be used as component D) and which are also preferred are, for example, the drying agents (or driers) known to the coatings specialist. Drying agents are metal salts of organic acids soluble in organic solvents and binders, which are usually added to oxidatively curable materials to catalyse the transfer of oxygen from the air (according to DIN 55945). The so-called primary drying agents may here be added alone or in combination with secondary drying agents (drying auxiliaries).

Corresponding cobalt, vanadium, tin, iron, cerium, copper or manganese salts may, for example, preferably be used as primary drying agents. Secondary drying agents which may be considered are, for example, the corresponding strontium or calcium compounds. The drying agents and drying auxiliaries are obtainable as commercial products. Drying agents may, for example, be obtained from the company Borchers under the name Octa-Soligen® for the corresponding octoates (for example, the primary drying agents Octa-Soligen® cobalt and Octa-Soligene® manganese), under the name Soligen® for the corresponding naphthenates and under the name Borchers® VP 0132 for organically modified vanadium compounds. Further drying agents may, for example, be obtained under the name Valirex, for example, Valirex Co 6% D60 as cobalt octoate, from the company Corn Van Loocke, Belgium. It is also possible that commercially available drying agents contain combinations of primary and secondary drying agents, e.g., Octa-Soligen® 173 from Borchers, containing cobalt, zirconium and barium salts of octanoic acid, in particular of the 2-ethylhexanoic acid isomer.

The drying agents conventionally assume the form of solutions in organic solvents, for example, as a 1-30% solution, but may also be provided in solvent-free form.

Substances which may preferably be used as component D) are cobalt, manganese, vanadium, iron, copper and cerium salts, in particular, the corresponding salts of naphthenic acid, benzoic acid, acetic acid, oxalic acid and octanoic acid, in particular, the 2-ethylhexanoic acid isomer. Cobalt octoates, manganese octoates, vanadium octoates, iron octoates and cerium octoates may in particular readily be used as well as cobalt naphtenates, manganese naphtenates, vanadium napthenates, iron naphthenates and cerium naphtenates.

Also mixed (transition) metal salts, such as, for example, mixed (transition) metal salts of ethylhexanoic acid and naphthenic acid may be used (e.g., ethylhexanoic acid and naphthenic acid in a ratio of 1 mole:1 mole).

The above-stated compounds may advantageously be combined, for example, with barium, calcium, strontium, zinc or zirconium salts (secondary drying agents), for example, the corresponding octoates or naphtenates, e.g., Octa-Soligen® Zirkonium and Octa-Soligen® Strontium from Borchers.

As already mentioned, organometallic compounds and metal coordination compounds may also in principle be used as component D). Organometallic compounds are compounds having a direct covalent bonding between a metal atom and a carbon atom of an organic group. Examples of organometallic compounds, which may be used are disclosed in U.S. Pat. No. 5,212,210.

Examples of metal coordination compounds are metal chelates. Metal chelates are compounds where a single ligand occupies more than one coordination position at the central metal atom. Examples of metal chelates are metal acetyl acetonates, such as, vanadium acetyl acetonate and manganese acetyl acetonate.

It goes without saying that also mixed forms of the above mentioned metal salts, organometallic compounds and metal coordination compounds may be used as component D), e.g., metal coordination compounds in form of a salt.

As already mentioned, the metal compounds D) may be used individually or in combination. The coating compositions contain component D) preferably according to a proportion of 10⁻⁵ to 10⁻¹ mol of metal of component D) (total of the mols of the corresponding metals and transition metals) per 100 g resin solids of the coating composition. Component D) is most preferably used in quantities such that a metal content of 10⁻⁴ to 5×10⁻² mol of metal per 100 g resin solids of the coating composition is obtained.

The resin solids of the coating composition is the total of all solids from component(s) A), optionally present component(s) B) and further optionally present resin solids constituents (component(s) E), i.e., components E1), E2) or E3) or combinations thereof; component(s) E) are explained below). The composition of the resin solids content of the coating composition is, for example, 50 to 100 wt-%, preferably 60 to 100 wt-% component(s) A), 0 to 30 wt-% component(s) B) and 0 to 50 wt-%, preferably 0 to 40 wt-% component(s) E), wherein the sum of the wt-% totals 100 wt-%. If the coating compositions, as is preferred, do not contain any component E), the resin solids content of the coating compositions is, for example, 70 to 100 wt-% component(s) A) and 0 to 30 wt-% component(s) B), wherein the sum of the wt-% totals 100 wt-%.

Preferably, the coating compositions contain substantially no physically drying binders E1). Containing substantially no physically drying binders E1) here means that while minimal proportions of physically drying binders E1) may optionally be present, they make no substantial contribution to the drying of the coating composition. It is most preferred that the coating compositions do not contain any physically drying binder E1). Physically drying binders E1) should here be taken to mean those binders which cure by release of solvent (organic solvent and/or water) at room temperature or at elevated temperature. The degree of polymerization and/or molar mass of the binders remain unchanged during this process.

Preferably, the coating compositions contain no beta-diketones. Preferably, no peroxides are mixed into the coating compositions.

Although this is not preferred, the coating compositions may be dual cure coating compositions, i.e., the coating compositions may, in addition to component A) and optionally present component B), or in addition to the free-radically polymerizable olefinically unsaturated groups of those components, contain further binder components E2) and/or crosslinker components E3) and/or further functional groups that allow for chemical cross-linking by an additional thermal curing mechanism, for example, by addition and/or condensation reactions of appropriate functional groups.

The olefinic double bonds capable of free-radical polymerization and the functional groups that react together in the manner of addition and/or condensation reactions may be contained, in principle, in the same binder and/or in separate binders.

The functional groups that react together in the manner of addition and/or condensation reactions will be referred to hereinafter as further reactive functional groups. They are reactive functional groups I and reactive functional groups II complementary to the latter. The reactive functional groups I and reactive functional groups II may be present in the same binder and/or in separate binders.

The addition and/or condensation reactions in the above mentioned meaning are cross-linking reactions in coatings chemistry known to the skilled person, such as, for example, the ring-opening addition of an epoxide group to a carboxyl group with the formation of an ester group and an hydroxyl group, the addition of an hydroxyl group to an isocyanate group with the formation of a urethane group, the addition of an optionally blocked amino group to an isocyanate group with the formation of a urea group, the reaction of an hydroxyl group with a blocked isocyanate group with the formation of a urethane group and dissociation of the blocking agent, the reaction of an hydroxyl group with an N-methylol group with dissociation of water, the reaction of an hydroxyl group with an N-methylol ether group with dissociation of the etherification alcohol, the transesterification reaction of an hydroxyl group with an ester group with dissociation of the esterification alcohol, the transurethanization reaction of an hydroxyl group with a carbamate group with alcohol dissociation, the reaction of a carbamate group with an N-methylol ether group with dissociation of the etherification alcohol, the addition of an amino group to an epoxy group with ring opening and formation of a secondary hydroxyl group, and the addition reaction of an amino group or of an aceto acetyl group to a group with olefinically unsaturated double bonds, e.g., an acryloyl group.

Dependent on their intended use, the coating compositions may contain pigments and/or fillers (extenders) according to a pigment plus filler/resin solids weight ratio of, for example, 0:1 to 1.5:1. Unpigmented coating compositions are, for example, coating compositions formulated in conventional manner as clear coats. Pigmented coating compositions may contain color-imparting and/or special effect-imparting pigments. Suitable color-imparting pigments are any conventional coating pigments of an organic or inorganic nature. Examples of inorganic or organic color-imparting pigments are titanium dioxide, iron oxide pigments, carbon black, azo pigments, phthalocyanine pigments, quinacridone or pyrrolopyrrole pigments. Examples of special effect-imparting pigments are metal pigments, for example, made from aluminum or copper; interference pigments, such as, metal oxide coated metal pigments, titanium dioxide coated mica. The coating compositions may also contain transparent pigments and/or soluble dyes. Examples of usable fillers are silicon dioxide, aluminum silicate, barium sulfate, calcium carbonate and talc.

Apart from constituents C) and D) the coating compositions may also contain conventional additives, e.g., conventional coating additives. Examples of conventional coating additives include levelling agents, rheological agents, thickeners, defoamers, wetting agents, anticratering agents, catalysts, antioxidants and light stabilizers based on HALS products and/or UV absorbers. The additives are used in conventional amounts known to the person skilled in the art.

The coating compositions may be liquid, solvent- and/or water-containing coating compositions having a solids content (consisting of the resin solids plus the optional components: pigments, fillers, non-volatile additives) of, for example, 30 to below 100 wt %, in particular from 40 to 80 wt % or so-called 100 % systems in the form of liquid, solvent- and water-free coating compositions or in the form of powder coatings. The aqueous coating compositions may be solutions or dispersion systems in the form of emulsions or suspensions.

The organic solvents that may be contained in the coating compositions are conventional paint solvents. These may, for example, originate from the preparation of the binders or may be added separately.

Examples of such solvents are glycol ethers, such as, ethylene glycol monobutyl ether, diethylene glycol monobutyl ether, dipropylene glycol dimethyl ether, dipropylene glycol monomethyl ether, ethylene glycol dimethyl ether; glycol ether esters, such as, ethylene glycol monoethyl ether acetate, ethylene glycol monobutyl ether acetate, diethylene glycol monobutyl ether acetate, methoxypropyl acetate; esters, such as, butyl acetate, isobutyl acetate, amyl acetate; ketones, such as, methyl ethyl ketone, methyl isobutyl ketone, diisobutyl ketone, cyclohexanone, isophorone; alcohols, such as, methanol, ethanol, propanol, butanol; aromatic hydrocarbons, such as, xylene, Solvesso® 100 (a mixture of aromatic hydrocarbons with a boiling range of 155 to 185° C.), Solvesso® 150 (a mixture of aromatic hydrocarbons with a boiling range of 182 to 202° C.) and aliphatic hydrocarbons.

In process step (2), the coating composition curable by free-radical polymerization of olefinic double bonds on exposure to UV radiation is applied onto the surface of the substrate, visible surfaces, in particular the substrate outer skin, being purposefully coated. Said purposeful coating may, however, also include one or more shaded zones or portions of shaded zones. If said purposeful coating does not proceed within the shaded zones, the latter are however at least unavoidably exposed to overspray which must likewise be cured at least to such an extent that the usability of the finished object is not impaired, for example, such that it is not tacky.

Application may precede in a manner and in a dry film thickness suitable for the intended purpose, in a range of, for example, 5 μm to 5 mm, in particular 10 μm to 100 μm. Application may proceed, for example, by means of spraying. As already mentioned above, application may proceed as a single layer coating or in the context of multilayer coating, for example, application of a primer surfacer layer or in particular a clear coat layer as the outer coating layer of a multilayer coating, especially on automotive bodies or body parts.

In the case of liquid coating compositions, depending on their nature, in general a flash-off phase, which serves to remove volatile components such as, solvents and/or water, is provided before the UV irradiation in the final process step (3). Flashing-off is performed, for example, for 5 to 10 minutes at an air temperature of 20 to 80° C. In the case of a powder coating composition, prior to UV irradiation in the final process step (3), the powder coating layer is melted and caused to merge by exposure to heat, for example, for 5 to 10 minutes at an object temperature of 80 to 160° C.

In process step (3), the coating layer applied from the coating composition is cured by UV irradiation and the consequently induced free-radical polymerization of olefinic double bonds and optionally, additionally by supply of thermal energy in the event that the coating composition used is a dual-cure coating composition.

UV irradiation of the substrate may proceed without special equipment to achieve purposeful UV irradiation of the coated surfaces located in shadow zones. For example, in the case of automotive body coating, purposeful UV irradiation of the coated outer body skin under conditions, which allow UV radiation to gain access to the shadow zones is sufficient. For example, in order to achieve UV irradiation of the surfaces located in shadow zones and do not belong to the outer body skin, i.e., door entries and optionally, further internal body surfaces, it is sufficient if the body doors are opened or open, for example, by an angle ranging from 10 degrees to an angle corresponding to complete opening before or during the purposeful UV irradiation of the outer body skin. While the outer body skin may in this manner purposefully be irradiated with UV radiation, the UV radiation or UV radiation dose which reaches the shadow zones with the doors open is sufficient to achieve a curing of the coating which proceeds at least to such an extent that adequate usability is achieved.

UV irradiation of the coated substrates may, for example, proceed in a belt unit fitted with one or more UV radiation emitters or the substrates and/or the UV radiation emitter(s) are moved relative to one another during irradiation. For example, the substrates may be moved through an irradiation tunnel fitted with one or more UV radiation emitters and/or a robot equipped with one or more UV radiation emitters may guide the UV radiation emitter(s) over the substrates.

If desired, UV irradiation of surfaces located in shadow zones may be assisted, for example, by using mirror systems to propagate diffuse UV light into the substrate interior or by using robots equipped with UV radiation sources in order purposefully to UV-irradiate the surfaces located in shadow zones.

UV irradiation may proceed in one or more temporally and optionally, spatially separate steps. UV irradiation may take place continuously or discontinuously (in cycles).

In principle, during UV irradiation, the duration of irradiation, object distance and/or radiation output of the UV radiation emitter may be varied, so adjusting the radiation dose. A sufficiently high radiation dose is here vital to achieving sufficient curing by free-radical polymerization which ensures that technical requirements are met, such as, for example, hardness, resistance to chemicals and scratching or weathering resistance. In the case of an outer automotive body skin, conventional UV-radiation doses are in the range from, for example, 500 to 3000 mJ per square centimeter.

The preferred source of radiation comprises UV radiation sources emitting in the wave length range from 180 to 420 nm, in particular from 200 to 400 nm. Examples of such continuously operating UV radiation sources are optionally doped high, medium and low pressure mercury vapor emitters and gas discharge tubes, such as, for example, low pressure xenon lamps. Discontinuous UV radiation sources may, however, also be used. These are preferably so-called high-energy flash devices (UV flash lamps for short). The UV flash lamps may contain a plurality of flash tubes, for example, quartz tubes filled with inert gas, such as, xenon. The UV flash lamps have an illuminance of, for example, at least 10 megalux, preferably, from 10 to 80 megalux per flash discharge. The energy per flash discharge may be, for example, 1 to 10 kJ.

The irradiation time with UV radiation when UV flash lamps are used as the UV radiation source may be, for example, in the range from 1 millisecond to 400 seconds, preferably, from 4 to 160 seconds, depending on the number of flash discharges selected. The flashes may be triggered, for example, about every 4 seconds. Curing may take place, for example, by means of 1 to 40 successive flash discharges.

If continuous UV radiation sources are used, the irradiation time may be, for example, in the range from a few seconds to about 5 minutes, preferably, less than 5 minutes.

The distance between the UV radiation sources and the surface to be irradiated may be, for example, 5 to 60 cm.

If the coating composition used in process step (2) is a dual-cure coating composition, thermal energy may be supplied in conventional manner, for example, by convection and/or infrared irradiation, to cure the coating layer by means of one or more additional thermal crosslinking mechanisms. The additional thermal curing may be performed before, during and/or after the UV irradiation.

The process according to the invention makes it possible to provide three-dimensional shaped substrates, in particular automotive bodies with a coating layer, in particular, for example, with a clear top coat layer or a transparent sealing layer, of a coating composition curable by free-radical polymerization of olefinic double bonds on exposure to UV irradiation and to cure said coating layer. The process can be carried out successfully in the presence of atmospheric oxygen. The coating composition used need not here be a dual-cure coating composition; it is sufficient if the coating composition is curable solely by free-radical polymerization of olefinic double bonds on exposure to UV radiation (on UV irradiation) and does not contain thermally curable components or functional groups. In the process according to the invention, during UV irradiation in process step (3), the coating layer applied in shadow zones generally receives lower radiation doses than the coating layer applied on outer surfaces which are directly accessible to an external observer and to spray coating, for example, down to as little as only 5 mJ per square centimeter. The coating layer located in shadow zones may in individual cases be less fully cured and not achieve in all respects the technical level of the coating layer on said outer surfaces, but surfaces usable for practical purposes are nevertheless obtained. It must be borne in mind in this connection that much higher technical requirements are placed on the coating layer on the outer surfaces directly accessible to an external observer and to spray coating, for example, a clear coat layer on the body outer skin, than are placed on the coating layer on the other surface zones which, in service, are not exposed or not exposed to the same extent to environmental and service conditions to which the outer surfaces are exposed.

The following Examples illustrate the invention. The abbreviation “pbw” means—parts by weight-.

### EXAMPLES

Production of a Solution of a Urethane Acrylate A):

An 80 wt-% solution of a urethane acrylate in butyl acetate was prepared by initially dissolving 0.125 mole of neopentyl glycol at 65° C. in butyl acetate. 1 Mole of trimeric hexane diisocyanate was then added at 65° C. and the batch was heated to 70° C. After the exothermic reaction had ended, heating was continued at 80° C. until a constant NCO value was obtained. 4-Methoxyphenol (inhibitor) and dibutyltin dilaurate (catalyst) were then added in a quantity of 0.05 wt-% in each case, based on the total batch. 2.75 Moles of butane diol monoacrylate were added at 60° C. in such a way that a temperature of 80° C. was not exceeded. After an NCO value of <0.1 was obtained, a solids content of 75 wt-% was then adjusted with butyl acetate.

Production of Transparent Coating Compositions

Coating compositions 1 and 2 were produced by vigorously mixing the following components with different components D), while the corresponding comparison coating compositions 1 and 2 were produced without component D):

Coating Composition 1

43.77 pbw of the 75 wt-% solution of the urethane acrylate A)
10.94 pbw Ebecryl® 5129 (conventional commercial aliphatic urethane acrylate from UCB)
0.98 pbw Darocur® 1173 (conventional commercial photoinitiator from CIBA)
0.33 pbw Irgacure® 819 (conventional commercial photoinitiator from CIBA)
0.11 pbw Byk® 301 (conventional commercial flow additive from BYK)
0.45 pbw Byk® 348 (conventional commercial surface additive based on polydimethylsiloxane from Byk)
0.55 pbw Tinuvin® 400 (conventional commercial UV absorber from CIBA) 40.68 pbw butyl acetate
2.19 pbw Octa Soligen® Fe ⅞ (conventional commercial drying agent based on the iron salt of 2-ethylhexanoic acid from Borchers)
   Comparison Coating Composition 1

Coating composition 1, but without Octa Soligen® Fe ⅞, was used as comparison coating composition 1.

Coating Composition 2

80.19 pbw of the 75 wt-% solution of the urethane acrylate A)
1.36 pbw Darocur® 1173 (conventional commercial photoinitiator from CIBA)
0.45 pbw Irgacure® 819 (conventional commercial photoinitiator from CIBA)
0.81 pbw Byk® 348 (conventional commercial surface additive based on polydimethylsiloxane from Byk)
16.58 pbw butyl acetate
0.61 pbw Octa Soligen 69® (conventional commercial drying agent based on the cobalt and zirconium salts of 2-ethylhexanoic acid from Borchers)
   Comparison Coating Composition 2

Coating composition 2, but without Octa Soligen® 69, was used as comparison coating composition 2.

Coating compositions 1 and 2 and comparison coating compositions 1 and 2 were each spray-applied to a dry film thickness of 30 μm onto steel test panels provided with a multilayer coating structure of electrodeposition primer, primer surfacer, base coat and clear coat (clear coat sanded on the surface). After a 10 minute flash off at 80° C., the transparent coating layers were cured by UV irradiation (curing conditions 1. to 4.:1. mercury medium pressure radiator, UV radiation intensity of 1910 mW/cm² of coated surface and a UV radiation dose of 1750 mJ/cm² of coated surface; 2. mercury medium pressure radiator, UV radiation intensity of 200 mW/cm² of coated surface and a UV radiation dose of 185 mJ/cm² of coated surface; 3. conditions like 1. but under nitrogen inert gas atmosphere; 4. conditions like 2. but under nitrogen inert gas atmosphere; curing conditions 1. and 3. correspond to purposeful UV irradiation of an outer surface fully accessible to UV irradiation, whereas curing conditions 2. and 4. are a simulation of the conditions in shaded areas).

Technological Properties of the Coatings Obtained

The cured coatings were tested with regard to hardness according to DIN 55676:

| | Hardness (N/mm²); dependent on curing | | | |
|---|---|---|---|---|
| Coating | conditions 1. to 4.: | | | |
| composition used | 1. | 2. | 3. | 4. |
| Coating | 153 | 110 | 157 | 153 |
| composition 1 | | | | |
| Comparison | 133 | 90 | 150 | 147 |
| coating | | | | |
| composition 1 | | | | |
| Coating | 134 | 95 | 126 | 98 |
| composition 2 | | | | |
| Comparison | 124 | 85 | 122 | 96 |
| coating | | | | |
| composition 2 | | | | |

What is claimed is:

1. A process for the production of a coating layer on a three-dimensional shaped substrate, comprising the steps:
(1) providing a three-dimensional shaped substrate,
(2) initial application of a coating layer on the surface of the substrate from a coating composition curable by free-radical polymerization of olefinic double bonds on UV irradiation and
(3) irradiating the coated substrate with UV radiation; wherein the coating composition contains the following constituents:
A) at least one free-radically polymerizable binder containing olefinically unsaturated groups,
B) optionally, at least one free-radically polymerizable monomeric reactive diluent containing one or more olefinically unsaturated groups,
C) at least one photoinitiator for free-radical polymerization, and
D) at least one metal compound selected from the group consisting of metal salt compounds containing the metal in the cation or in the anion or in the cation and in the anion of the compound, organometallic compounds, metal coordination compounds and combinations thereof, wherein said metal or metals is/are selected from the group consisting of metals of groups 13 and 14 of the periodic system of elements and transition metals, which metals or transition metals are able to occur in at least 2 oxidation states other than zero.

2. The process of claim 1, wherein the metal or metals are selected from the group consisting of titanium, vanadium, chromium, manganese, iron, cobalt, nickel, copper and cerium.

3. The process of claim 1, wherein the at least one metal compound D) is a metal salt of an organic or inorganic acid.

4. The process of claim 3, wherein the organic acid is selected from the group consisting of unsaturated higher fatty acids, resin acids, naphthenic acid, benzoic acid, acetic acid, oxalic acid and the isomers of octanoic acid.

5. The process of claim 3, wherein the inorganic acid is selected from the group consisting of sulfuric acid, phosphoric acid, boric acid, nitric acid and hydrochloric acid.

6. The process of claim 3, wherein the metal salt of an organic or inorganic acid is the cobalt, manganese, vanadium, iron, copper or cerium salt of naphthenic acid, benzoic acid, acetic acid, oxalic acid or octanoic acid.

7. The process of claim 3, wherein the metal salt is selected from the group consisting of cobalt octoates, manganese octoates, vanadium octoates, iron octoates, cerium octoates, cobalt naphtenates, manganese naphtenates, vanadium napthenates, iron naphthenates and cerium naphtenates.

8. The process of claim 1, wherein the at least one metal compound D) is present in the coating composition according to a proportion of 10⁻⁵ to 10⁻¹ mol of metal per 100 g resin solids of the coating composition.

9. The process of claim 8, wherein the at least one metal compound D) is present in the coating composition according to a proportion of 10⁻⁴ to 5×10⁻² mol of metal per 100 g resin solids of the coating composition.

10. The process of claim 1, wherein the resin solids content of the coating composition consists of 50 to 100 wt-% of component(s) A), 0 to 30 wt-% of component(s) B) and 0 to 50 wt-% of component(s) E), wherein the wt-% add up to 100 wt-% and wherein the component(s) E) are selected from the group consisting of physically drying binders E1), further binder components E2), crosslinker components E3) and any combinations thereof.

11. The process of claim 1, wherein the resin solids content of the coating composition consists of 70 to 100 wt-% of component(s) A) and 0 to 30 wt-% of component(s) B), wherein the wt-% add up to 100 wt-%.

12. The process of claim 1, wherein the coating composition is a coating composition selected from the group consisting of liquid solvent-containing coating compositions, liquid water-containing coating compositions, liquid solvent- and water-containing coating compositions, liquid solvent- and water-free coating compositions and powder coating compositions.

13. The process of claim 12, wherein the coating composition is a coating composition selected from the group consisting of liquid solvent-containing coating compositions, liquid water-containing coating compositions and liquid solvent- and water-containing coating compositions and wherein between process steps (2) and (3) a flash-off phase for the removal of volatile components is provided.

14. The process of claim 12, wherein the coating composition is a powder coating composition and wherein between process steps (2) and (3) the powder coating layer is melted and caused to merge by exposure to heat.

15. The process of claim 1, wherein the substrates have outer surfaces which are directly accessible to an external observer and to spray coating and surfaces which are not directly accessible to an external observer but are in principle accessible to spray coating and, optionally, wherein the substrates are composed of two or more components of identical or different materials.

16. The process of claim 1, wherein the substrates are selected from the group consisting of automotive bodies and body parts.

17. The process of claim 1, wherein the coating layer is applied as a single-layer coating or as a coating layer within a multilayer coating.

18. The process of claim 17, wherein the coating layer applied as a coating layer within a multilayer coating is selected from the group consisting of a primer surfacer layer applied on an electrodeposition primer layer, a final clear coat layer applied on a color-determining precoating and a transparent sealing layer applied on a per se ready multilayer coating.

19. The process of claim 1 being performed on an industrial scale.

20. The process of claim 1 being performed in the context of automotive original coating.
